(19) United States
(12) Patent Application Publication
(10) Pub. No.: US 2005/0200715 A1
(43) Pub. Date: Sep. 15, 2005

(54) Portable terminal device and device control method

(75) Inventor: Shingo Kakui, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/935,199

(22) Filed: Sep. 8, 2004

(30) Foreign Application Priority Data
Mar. 12, 2004 (JP) 2004-070738

(51) Int. Cl. H04N 5/781

(52) U.S. Cl. 348/211.99

(57) ABSTRACT

An image is acquired and displayed. A Code part among the displayed image is designated so that a command corresponding to the code is transmitted to a controlled object. Consequently, a code can be selected easily.

### CROSS-REFERENCE TO THE INVENTION

This application is based upon and claims the benefit of priority from the prior Japanese Patent Application No. 2004-070738, filed on Mar. 12, 2004; the entire contents of which are incorporated herein by reference.

### BACKGROUND OF THE INVENTION

1. Field of the Invention

The present invention relates to a portable terminal device which transmit a command to an object of control, for example, a video recorder and a DVD recorder.

2. Description of the Related Art

A remote control device is sometimes used for timer recording of a program on TV and the like. For this timer recording, it is required that a channel and times to start recording and end recording should be designated. By inputting G-Code presented in the TV program listings on the newspaper and the like, timer recording can be performed easily.

Incidentally, an art is disclosed in which timer recording of a program is performed with usage of an image signal acquired by moving an image pick up means. (See Japanese Patent Laid-open Application No. Hei 9-186810).

### SUMMARY OF THE INVENTION

In the prior art stated above, for selection of the program to be timer recorded, the image pickup means is required to be removed by a moving means in order to adjust a captured area, and an operation thereof is cumbersome.

In view of the above, it is an object of the present invention to provide a portable terminal device by which a target of timer recording can be easily selected.

A portable terminal device related to the present invention is constituted with an image acquisition unit configured to acquire an image, a display unit configured to display the acquired image, a designation unit configured to designate a position in the acquired image, a recognition unit configured to recognize a displayed data corresponding to the designated position, a command generation unit configured to generate a command corresponding to the displayed information which is recognized, and a transmission unit configured to transmit the generated command.

When the image acquisition unit acquires an image of a desired part of a TV program listings from, for example, a newspaper, the image of the TV program listings is displayed on the display unit. When the designation unit designates, for example, a G-Code part among the image of the TV program listings, the recognition unit recognizes contents of G-Code. Then, the command generation unit generates the command corresponding to the G-Code, and the transmission unit transmits the command to an object to be controlled.

By designating the position in the displayed image, a program to be timer recorded can be designated. With just selecting the position in the image, a selecting operation is performed easily.

Incidentally, the displayed information can be exemplified as a character string (the character includes a number), a figure, a symbol, a picture and the like.

(1) The designation unit can have either a touch panel mounted on the display unit or a scroll unit configured to scroll the position.

With usage of the touch panel or the scroll unit, the selecting operation can be performed easily.

(2) The displayed information can include G-Code information.

By selecting G-Code among the displayed information, setting of timer recording of the program can be set up.

(3) The portable terminal device can further have a G-Code judgment unit configured to judge whether the information included in contents displayed by the display unit is G-Code or not, and a display conversion unit configured to convert display by the display unit in accordance with judgment by the G-Code judgment unit.

The G-Code judgment unit discriminates G-Code included in the displayed contents, so that G-Code can be displayed differently from other displayed information. For example, G-Code is displayed emphasized, making selection of G-Code easier.

(4) The portable terminal device can further have an external information input unit configured to input a control code for the command of the command generation unit via a network.

By obtaining the control code for the command, it becomes possible to control various objects to be controlled.

### BRIEF DESCRIPTION OF THE DRAWINGS

FIG. 1 is a block diagram which shows a structure of a first embodiment of the present invention.

FIG. 2 is a perspective view which shows a front side of a remote control device applied to the first embodiment.

FIG. 3 is a perspective view which shows a back side of the remote control device applied to the first embodiment.

FIG. 4 is a perspective view which shows a side of a infrared port of the remote control device applied to the first embodiment.

FIG. 5 is a front view which shows a part of a TV program listings on, for example, a newspaper.

FIG. 6 is a front view which shows an example that an arbitrary position is photographed among the TV program listings on, for example, the newspaper.

FIG. 7 is a flowchart which shows operation of the first embodiment.

FIG. 8 is a block diagram which shows a second embodiment of the present invention.

### DESCRIPTION OF THE EMBODIMENTS

### First Embodiment

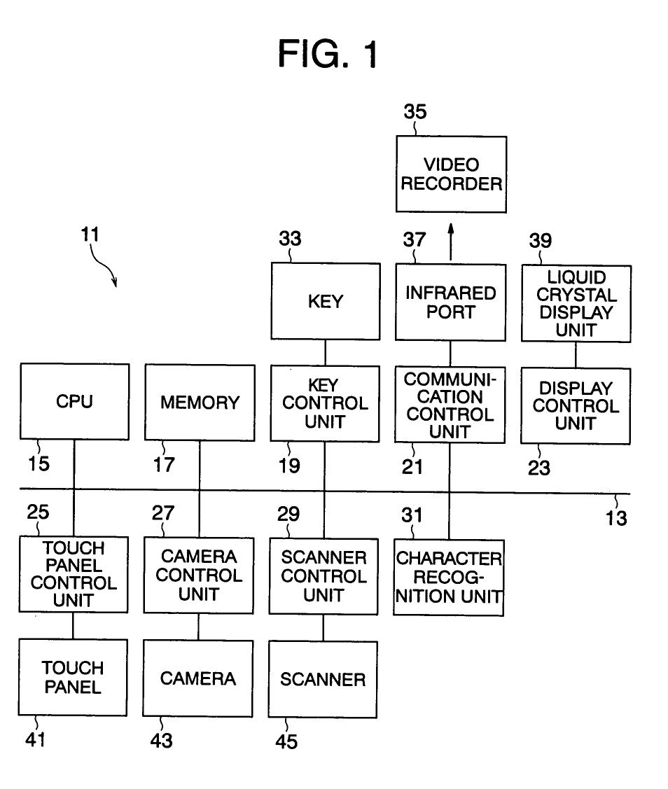

Hereinafter, a terminal device according to a first embodiment of the present invention will be described with reference to FIG. 1 to FIG. 7. FIG. 1 is a block diagram which shows a structure of the terminal device according to this embodiment.

Incidentally, the terminal device of this embodiment is a portable terminal device, and although a case of a remote control device 11 is exemplified, a terminal device in general including a remote control device, a cellular phone, a portable computer and the like can be adopted.

As shown in FIG. 1, a remote control device 11 is constituted with a CPU (central processing unit) 15, a memory 17, a key control unit 19, an communication control unit 21, a display control unit 23, a touch panel control unit 25, a camera control unit 27, a scanner control unit 29, and a character recognition unit (dictionary) 31, connected by a bus 13.

The CPU 15 functions, based on various programs and the like, as a recognition unit, a command generation unit, a G-Code judgment unit, and a display conversion unit. Details will be described later.

The memory 17 stores (temporarily stores) an image photographed (acquired) by a camera 43 or a scanner 45 (see FIG. 3) which will be described later. The memory 17 is, for example, a RAM (random access memory), a VRAM (video RAM) and the like, while a HD (hard disc) and the like can be adopted.

Incidentally, a concept of the memory 17 includes a ROM (read-only memory) for recording a program and others which will be described later, or an EPROM and the like.

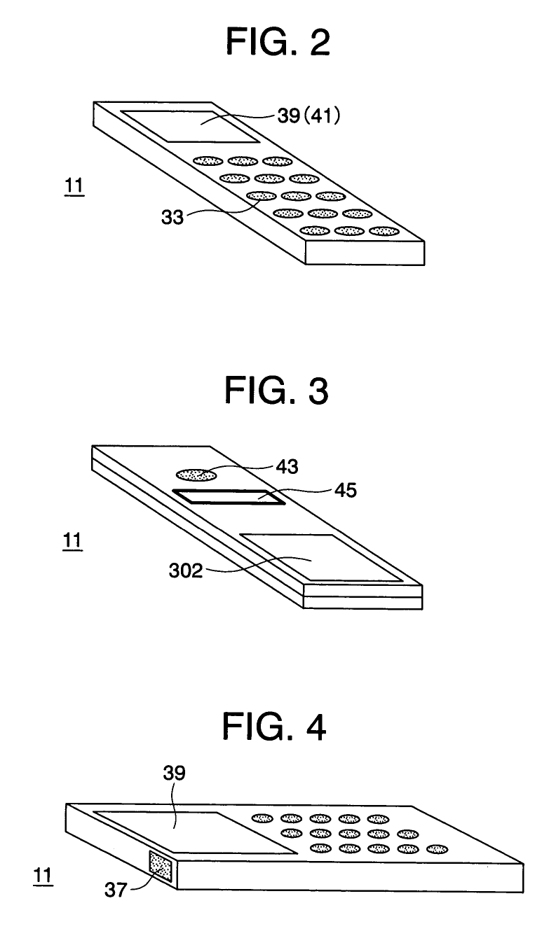

The key control unit 19 controls output of a predetermined signal to, for example, the CPU 15 and the like, based on an operation of a key 33 which is mounted on a front side of a main body of the remote control device 11 (see FIG. 2 and FIG. 4). Control of signal output includes a case in which each operation of the key 33 is detected and an output destination is controlled.

The communication control unit 21 controls an infrared port 37 (transmission unit, see FIG. 4) which is mounted on a side of the main body of the remote control device 11, in order to infraredly output a command which is generated by the CPU 15 (command generation unit) based on, for example, an operation of the key 33. What the command controls are, for example, playing, forwarding, stopping, and rewinding to be outputted to a video recorder 35 and the like, as well as various control codes for timer recording and others.

The display control unit 23 controls a display of a various images on a liquid crystal display unit 39 (display unit, see FIG. 2 and FIG. 4) which is mounted on the front side of the main body of the remote control device 11. Examples of the display on the liquid crystal display unit 39 are an initial view (for example, a menu view and the like), various operation screens to prompt selection of key 33 for operation, and an image (image of a TV program listings and others) acquired by a camera 43.

The touch panel control unit 25 detects a touched position on a touch panel 41 (designation unit) which is mounted on the liquid crystal display unit 39, and outputs a detected signal corresponding to the touched position.

The touch panel 41, being mounted on a display screen of the liquid crystal display unit 39, detects a position touched by a finger of a user on the display screen, and outputs a detected result to the CPU 15.

The CPU 15 converts an image displayed on the liquid crystal display 39, based on the detected signal outputted from the touch panel control unit 25. The CPU 15 generates and outputs to the communication control unit 21 a command to be outputted to the video recorder 35 and the like.

The CPU 15 decodes G-Code via a character recognition unit 31 (recognition unit) which will be described later, when the image of the TV program listings acquired by the camera 43 and the like is displayed on the liquid crystal display unit 39 and a position at which G-Code is displayed is recognized to be touched on the touch panel 41. Consequently, the CPU 15 generates and outputs to the communication control unit 21 a command related to recording setup, such as timer recording, a channel to be recorded, a record starting time, and a record ending time.

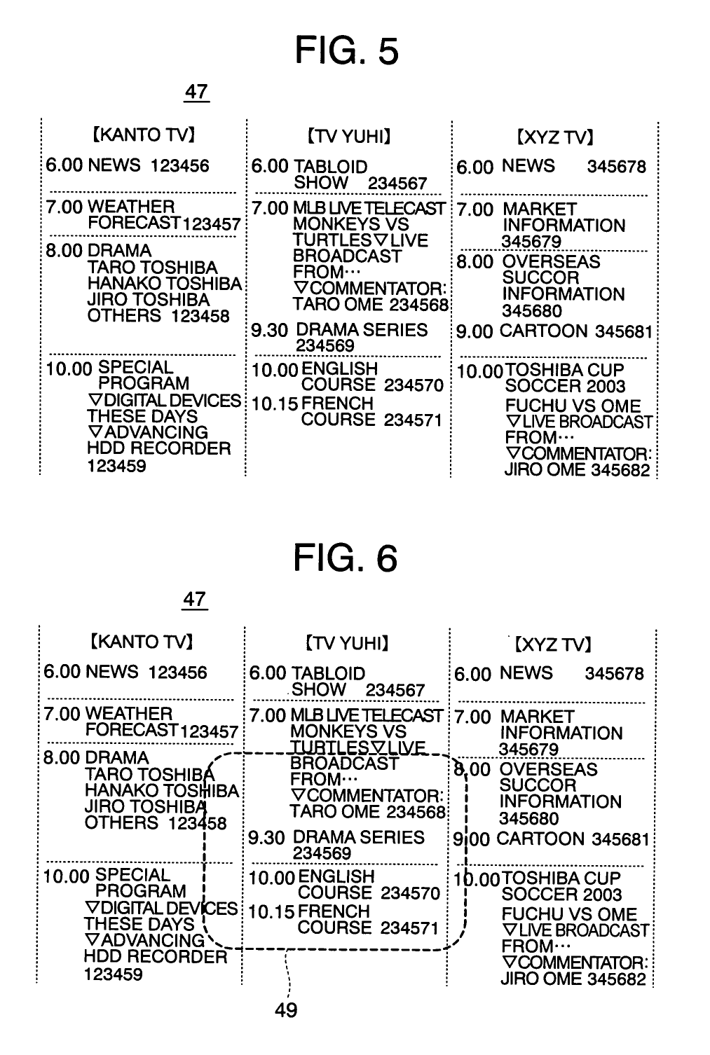

The camera control unit 27 controls start-up, focusing and so forth of the camera 43 (image acquisition unit, see FIG. 3) which is mounted on the back side of the main body of the remote control device 11, according to, for example, an operation of a predetermined key 33. Consequently, the camera 43 acquires from a TV program listings 47 (see FIG. 5) on, for example, a newspaper, an image of a TV program listings (for example, an area 49 shown with a dotted line on FIG. 6). Then, the camera control unit 27 outputs image acquisition data to the CPU 15 so that the memory 17 stores the image of the TV program listings acquired by the camera 43.

The CPU 15, when image acquisition data is inputted therein, makes the memory 17 store the image photographed by the camera 43, and also generates and outputs to the display control unit 23 a command for displaying the image of the TV program listings which is stored in the memory 17. The display control unit 23, on input of this command, reads the above-described image of the TV program listings from the memory 17, and make the liquid crystal display unit 39 display the image.

The scanner control unit 29 controls a scanner 45 (image acquisition unit) which is mounted on the back side of the main body of the remote control device 11, according to, for example, the operation of the predetermined key 33. Consequently, the scanner 45 acquires the image of the TV program listings (for example, the area 49 shown with the dotted line on FIG. 6). Then, the scanner control unit 29 outputs image acquisition data to the CPU 15 so that the memory 17 stores the image of the TV program listings acquired by the scanner 45.

Image acquisition data being inputted, the CPU 15 performs processing similar to the above and the display control unit 23 also conducts control similar to the above.

Incidentally, although in this embodiment the case of both the camera 43 and the scanner 45 being mounted is exemplified, it is a matter of course that either one can be independently mounted.

The character recognition unit 31 (recognition unit) decodes G-Code when the CPU 15 recognizes designation of G-Code (touch on the touch panel 41) among the image displayed on the liquid crystal display unit 39.

“G-Code”, developed by Gemstar Development Corporation, is a set of numbers into which four elements necessary for TV program timer recording (four elements of recording), i.e. “date”, “channel”, “program starting time”, “length of program”, are transformed. By input of G-Code to the video recorder 35, timer recording on the video recorder 35 is set up.

The character recognition unit 31 can be composed of hardware with a logic circuit and the like, but can be composed, as a matter of course, of software and a memory which provides various code data necessary for decoding G-Code.

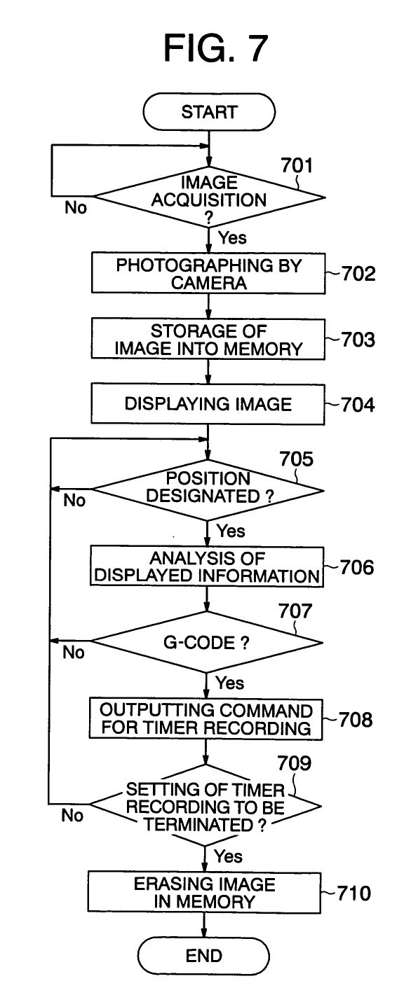

Operations for setting of timer recording according to this embodiment will be described. Processing of timer recording is performed by the CPU 15 based on a flowchart of timer recording program shown in FIG. 7.

In a step 701, whether image acquisition or not is judged. Judgment is conducted, for example, by determining whether an image acquisition key (not shown) for the camera mounted on the remote control device 11 is operated to ON or not.

If image acquisition is judged positive by an operation of the image acquisition key to ON, in a step 702, a start-up instruction is outputted to the camera control unit 27 so as to make the camera 43 start up, and then the TV program listings such as an selected area 49 in the TV program listings 47 on the newspaper is photographed.

In a step 703, the image of the photographed TV program listings is temporarily stored in the memory 17. In a step 704, the image of the TV program listings (area 49) temporarily stored in the memory 17 is displayed on the liquid crystal display unit 39.

Incidentally, it is convenient for the user's selection if, at the time of above-described display, included G-Code is automatically discriminated and emphasized by way of highlighting and the like. This discrimination can be conducted based on the touch at a certain position corresponding to the image on the touch panel 41.

In a step 705, whether the image displayed on the liquid crystal display unit 39 is designated or not is judged. The judgment can be conducted based on the touch at a certain position corresponding to the image on the touch panel 41.

In a step 706, displayed information according to the touched position is analyzed. In a step 707, based on an analysis result whether the displayed information is G-Code or not is judged. This judgment is conducted based on, for example, whether the displayed information which is designated is a one-to eight-digit number or not.

If necessary, contents represented by G-Code are displayed. For example, the channel, the date, the record starting time, and a recording time are displayed.

If the displayed information is judged not to be a G-Code, the step 705 is repeated and the position is designated.

If G-Code is judged positive, in a step 708, a command for timer recording is generated and outputted from the infrared port 37 to the video recorder 35.

In a step 709, whether setting of timer recording is to be terminated or not is judged. Termination of setting of timer recording can be judged, for example, by whether the predetermined key 33 is pressed or not.

If in the step 709 it is judged that setting of timer recording is to be terminated, in a step 710 the image photographed in the above is erased and then this flow ends. If in the step 709 it is judged that setting of timer recording is not to be terminated, the step 705 is repeated and the position is designated, so that additional setting of timer recording can be performed.

In this embodiment, a selected area on the TV program listings 47 is photographed by the camera 43 of the remote control device 11 and displayed on the liquid crystal display unit 39. Then, the position of G-Code on the image (on the touch panel 41) is touched, so that the CPU 15 analyses contents of G-Code and outputs the command for timer recording.

As a result, it is possible to perform processing of timer recording on the video recorder 35 and the like with ease and without mistake. In addition, there is no need to change a system of the video recorder 35.

In the TV program listings on the newspaper or a magazine, G-Code is printed so densely that aiming and photographing a specific program can be sometimes difficult. However, since the image of the TV program listings which is displayed on the liquid crystal display unit 39 can be designated at hand, a desired G-Code can be surely designated even if photographing only one TV program is not possible.

Incidentally, when the touch panel is touched, the CPU 15 can be search whether a coded information is present or not in a surrounding area of the touched position, especially in a horizontal direction, so that with a slight touch G-Code analysis processing can be surely conducted. In view of operationality, it can be made possible that the image of the TV program listings which is displayed on the liquid crystal display unit 39 is displayed enlarged.

### Second Embodiment

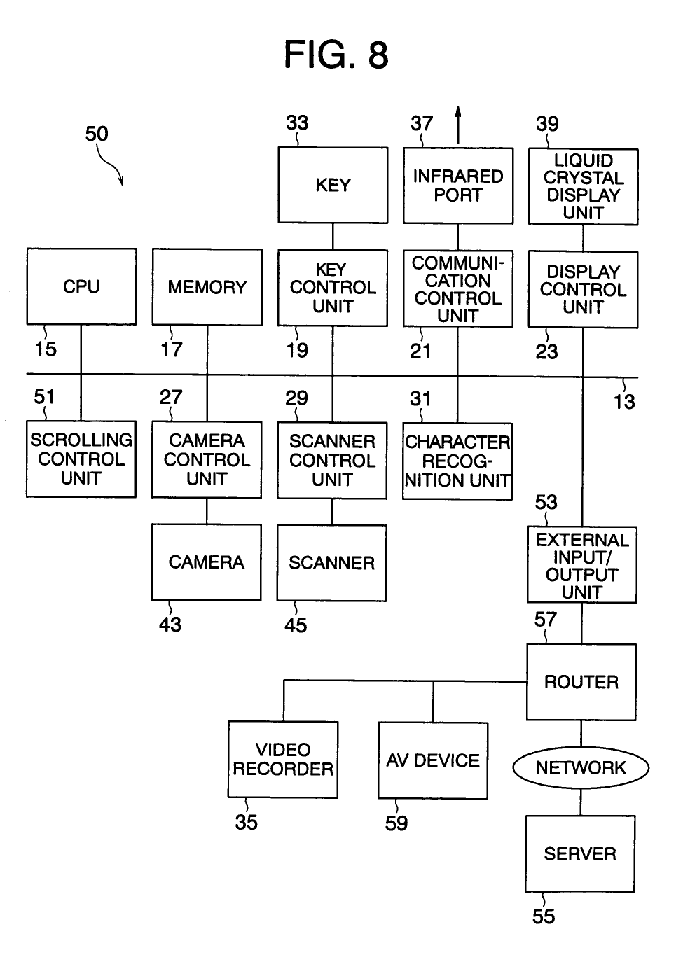

A terminal device related to a second embodiment of the present invention will be described with reference to FIG. 8. FIG. 8 is a block diagram which shows a structure of the terminal device according to this embodiment. Note that the same reference numerals are assigned to the same units as those in the configuration of the terminal device of the first embodiment and explanation thereof will be restrained.

The terminal device of this embodiment is also a portable terminal device, and although a case of a remote control device 50 is exemplified, a terminal device in general including a remote control device, a cellular phone, a portable computer and the like can be adopted.

As shown in FIG. 8, the remote control device 50 of this embodiment is different from the remote control device 11 described in the first embodiment in that the former does not have the touch panel 41 and is structured to include a scroll control unit 51 and an external input/output unit 53. The other structure is the same as that of the first embodiment.

The scroll control unit 51 (designation unit), when detecting start-up of a camera 43 or a scanner 45, for example, displays a designation indicator such as a cursor or a band-like area (not shown) in an image of a TV program listings which the camera 43 and the like photographs and a liquid crystal display unit 39 displays thereon. The scroll control unit 51 also scrolls the cursor and the like upward or downward when detecting an operation of a key 33 for scrolling (scroll unit) which is mounted on the remote control device 50.

The scroll control unit 51 can have a function to make the CPU 15 judge a size of area displayed respective information in the image of the TV program listings, and to adjust a size (vertical width) of the cursor and the like based on a judgment result, when the cursor and the like is scrolled. It is convenient for designation of G-Code if the size of the cursor and the like is adjusted based on the size of a displaying area of information (G-Code and others) which is overlapped thereby. For example, it will become possible that, when plural horizontal character strings are aligned vertically in the image of the TV program listings which is displayed on the liquid crystal display unit 39, scrolling is performed, with the size of the cursors and the like being changed based on the size of each character string.

For example, when a key 33 for designation (designation unit) mounted on the remote control device 50 is operated to ON after a scroll, the CPU 15 performs analysis processing of displayed information (G-Code and others) which is overlapped by the cursor and the like, command generation processing (i.e. generation processing of a timer recording command), and command transmission processing (i.e. transmission processing to the video recorder 35) and so on.

The external input/output unit 53 (external information input unit) receives, for example, various control codes for a video recorder 35 and various TV program information from outside (for example, server 55).

The external input/output unit 53 can access the server 55 on a network (Internet) with wired connection or wireless connection (for example, by radio wave, infrared ray and the like), directly or via a router 57.

A reason for using the external input/output unit 53 is, as shown in FIG. 8, to enable to respond to a user who owns a domestic LAN with, for example, various devices at home (AV device 59, video recorder 35 and the like) of an arbitrary manufacture.

For example, in a case that various devices at home and the like are desired to be controlled by the single remote control device 50, by the external input/output unit 53 various control codes for the new video recorder 35 can be obtained from, for example, the server 55.

The program information corresponding to G-Code in the TV program listings 47 photographed by the camera 43 and the like can be obtained from Internet and the like and then displayed on the liquid crystal display unit 39.

For timer recording in this embodiment, a position is designated, instead of by the touch on the touch panel 41 in the first embodiment, by a scroll of the cursor and the like with a scrolling key as well as by detection of input of a designating key. Others are basically the same as in the first embodiment, so that detailed descriptions will be restrained.

Acquisition of the control code and the like for various devices from the remote control device 50 is substantially the same as in the first embodiment, so that detailed descriptions will be restrained.

In this embodiment, a selected area in the TV program listings 47 is photographed by the camera 43 and the like of the remote control device 11 and stored in the memory 17, and then displayed with the cursor and the like on the liquid crystal display unit 39. After that, by an operation of the scrolling key as well as an operation of a selection key, the CPU 15 analyses contents of G-Code which is overlapped by the cursor and the like, outputting the command for timer recording.

As a result, it is possible to perform processing of timer recording on the video recorder 35 and the like with ease and without mistake. In addition, there is no need to change a system of the video recorder 35.

### Other Embodiments

The present invention is not limited to the above-described embodiments, and expansion and change thereof may be made. The expanded and changed embodiments are also included in the technical range of the present invention.

Though in the above embodiments G-Code in the TV program listings on the newspaper, the magazine and so forth is read out, the present invention can be also applied to read out a control code (used for controlling a controlled object) in general which is presented on paper by printing and the like. Whether the control code or not can be judged by structure thereof. Structure of a control code can be exemplified as (1) consisting of only numeric characters and upper and lower limits of a digit number thereof is specified, and (2) consisting of only alphanumeric characters and upper and lower limits of each digit number thereof is specified (such as a control code consisting of three digit alphabets and four digit numbers). According to structure of the control code described above, whether the control code or not can be judged.

1. A portable terminal device, comprising:
an image acquisition unit configured to acquire an image;
a display unit configured to display the acquired image;
a designation unit configured to designate a position in the displayed image;
a recognition unit configured to recognize displayed information corresponding to the designated position;
a command generation unit configured to generate a command corresponding to the displayed information which is recognized; and
a transmission unit configured to transmit the generated command to an object to be controlled.

2. The portable terminal device as set forth in claim 1, wherein said designation unit includes one of a touch panel mounted on said display unit and a scroll unit configured to scroll the position.

3. The portable terminal device as set forth in claim 1, wherein the displayed information includes G-Code information.

4. The portable terminal device as set forth in claim 1, further comprising:
a G-Code judgment unit configured to judge whether information included in contents displayed by said display unit is G-Code or not; and
a display conversion unit configured to convert display by said display unit in accordance with the judgment by said G-Code judgment unit.

5. The portable terminal device as set forth in claim 1, further comprising:
an external information input unit configured to input a control code for a command of said command generation unit via a network.

6. A device control method, comprising:
acquiring an image;
displaying the acquired image;
designating a position in the displayed image;
recognizing information corresponding to the designated position;
generating a command corresponding to the recognized information; and
transmitting the generated command to a controlled object device.

7. The device control method as set forth in claim 6,
wherein designating includes using one of a touch panel or a scroll unit configured to scroll the position.

8. The device control method as set forth in claim 6,
wherein the recognized information includes G-Code information.

9. The device control method as set forth in claim 6, further comprising:
judging whether the displayed image includes G-Code or not; and
converting the display in accordance with the judgment.

10. The device control method as set forth in claim 6, further comprising:
inputting a control code for the command via a network.
